(19) United States
(12) Patent Application Publication
(10) Pub. No.: US 2007/0173750 A1
(43) Pub. Date: Jul. 26, 2007

(54) Massage apparatus with spherical elements

(76) Inventor: Anne Lenaye Hudock, North Berwick, ME (US)

Correspondence Address: BOHAN, MATHERS & ASSOCIATES, LLC, PO BOX 17707, PORTLAND, ME, 04112-8707, US

(21) Appl. No.: 11/340,134

(22) Filed: Jan. 26, 2006

(51) Int. Cl. A61H 15/00

(52) U.S. Cl. 601/128; 601/131; 601/115; 601/118

(57) ABSTRACT

An exercise device for promoting the natural movement and agility of facet joints in the spinal column. The device is an exercise surface formed by pairs of spherical elements arranged along a longitudinal axis. The spheres are dimensioned such that, when a user lies supine on the exercise surface, the spheres protrude up into the areas near the facet joints along both sides of the spinal column and massage the supportive muscle and ligament tissue that supports the posterior spine. The spherical elements may be freely rotating spheres mounted in a frame or partial spherical elements molded into a base material.

### BACKGROUND INFORMATION

1. Field of the Invention

The present invention relates to the field of exercise or massage equipment. More particularly, the invention relates to an exercise surface for relieving tense back tissue.

2. Description of the Prior Art

The human spine is usually constructed of 24 vertebrae that are stacked to a spinal column. Each vertebra has bone protrusions, called “transverse processes,” that extend laterally to each side of the spinal foramen on the posterior spinal column and that connect or interlock with corresponding transverse processes of adjacent vertebrae. These processes protect and provide stability to the spine. There are usually five spinous processes per vertebra, the fifth one being a singular posterior one. “Facet joints” are cartilaginous joints that provide a flexible cushion between transverse processes of adjacent vertebrae and allow the bony process of one vertebra to move relative to the process of the adjacent vertebra when the spinal columns flexes, bends, or twists. Looking at a posterior view of the spinal column, the facet joints of the vertebrae form a continuous, flexibly interlocked ridge along each side of the column, with a bilateral spinal groove formed between the transverse processes and the spinous processes that extend posteriorally along the center of the spinal column.

Supple unrestricted facet joints, muscles and ligaments enable the spine to painlessly flex, bend, and twist. Muscles and/or ligaments that support the facet joints can become restricted (unable to move fully in a natural fashion) or knotted (stiffened tissue). The facet joints themselves can become fixed in subluxation (out of joint or out of position). Restriction and/or stiffness of the back muscles and ligaments or subluxation of the facet joints results in stiffnes and/or pain in the back and elsewhere, as well as limited movement. When this happens, common treatments include a back massage or chiropractic adjustment, with the goal of releasing the tension and correcting the restriction or subluxation.

Many devices known as back exercisers are intended to exercise muscles in the back to relieve back pain. They almost all have a great disadvantage with regard to relieving stiffness or subluxation of the facet joints in that they are not constructed in a manner that adjusts the facet joints directly or massages the supportive tissue around the joints. The massage components are often too large or spaced too far apart to be effective. In the end, most such exercise devices apply some type of pressure to back muscles in general, without applying pressure directly to the facet joints. This type of exercise is ineffective in releasing tension, subluxation, and stiffness in the facet joints.

A further disadvantage of many back exercisers is that they are designed to be placed on the floor, forcing the user to get down onto the floor in order to use them. The act of getting into a supine position on a device that is close to floor level can cause discomfort to one already suffering from back pain and make it very difficult for the person to get up again after exercising.

What is needed, therefore, is an exercise device that will gently yet effectively relax knotted or tense muscles and ligamentous tissue that support the facet joints. What is further needed is such a device that will correct subluxation and adjust the facet joints. What is yet further needed is such a device that is simple and comfortable to use. Finally, what is needed is such a device that is lightweight and inexpensive to manufacture.

### BRIEF SUMMARY OF THE INVENTION

The invention is a facet-joint exerciser that gently releases and corrects subluxation in the facet joints along the spinal column and softens away knots and tension in the tissue supporting these joints. Much back pain and tension is caused by spinal subluxation, most of which, including rotation, is caused by fixation or stiffness in the muscular and ligamentous bed that supports the facet joints. This fixation prevents the facet joints from moving freely and results in limited ability to flex, bend, or twist the spine painlessly.

The facet-joint exerciser according to the invention comprises an exercise surface mounted in a frame. The exercise surface is constructed of a series of parallel rods, on which are mounted a combination of spheres and rollers. The exercise surface is curved slightly, to correspond to the natural curvature of the human spine. A pair of spheres is mounted in the center of each rod, thereby forming a double row of spheres along the center length dimension of the exercise surface. Ideally, each pair of spheres rotates freely on the rod, that is, independently of each other. Rollers are mounted on the outer ends of the rods. These rollers are ideally free-rolling as well. The outer diameter of the rollers may be less than that of the spheres. Alternatively, the outer diameter of the rollers may be the same or greater than that of the spheres. In the latter case, the rollers are best covered with a padding that is more easily compressible than the outer surface of the spheres. Thus, when the back of the user is supported along the plane of the rollers, a certain dimension of the spheres is forced into the bilateral spinal groove, thereby pressing against the erector spinae muscles and their underlying muscles and ligaments, and applying pressure to the deeper, underlying facet joints and transverse processes.

The facet joints of a vertebra are close together, typically within a range of about one to one and one-half inches apart on an average adult human. Accordingly, the spheres in the exercise surface according to the invention are held close together, to ensure that the spheres are forced to follow the contours of the spine and that the curved surfaces of the spheres move directly along the tissue that supports and surrounds the facet joints. The purpose of the spheres is to gently release and soften the tissue of the spinal groove, as well as to correct the alignment and movement patterns of the deeper lying facet joints that are possibly subluxated. It also corrects vertebral rotations by applying bilateral pressure to the transverse processes. The vertebrae tend to self-correct when this type of pressure is applied. To this end, the spheres must be firm, yet not so rigid as to be experienced as less than gentle. The spheres are best constructed as rubber balls, or as spheres with a hard core and a rubber coating or other type of compressible padding. The outer surface of the spheres may be smooth or textured. Other materials and other combinations of materials may also be used for the spheres. The critical feature of the sphere is that it provide the necessary firmness to move into the spinal groove along the facet joints, yet have enough give to it that it does not cause pain or harm as it does so. The rollers may be wooden rollers or have a hard core with a foam or other type of padding for comfort.

The rods that form the exercise surface are offset in a vertical plane along the length dimension of the frame to form a curved bed that accommodates the natural curvature of the human spine. Ideally, the frame is mounted on legs, so that it is above the floor level, at a height that is convenient for the user to recline on it. The frame may be height adjustable. The frame may have overhead or side hand grips that the user may grasp. A foot brace may also be provided.

Use of the facet-joint exerciser according to the invention is a kinetic exercise, that is, the body of the user moves along the surface of the exerciser. The user lies supine on the exercise surface, grasps the hand grips and pulls/pushes on the hand grips and the foot brace to move his or her body several inches up and down along the exercise surface. The spheres promote a resetting of fixated vertebrae by gently and thoroughly softening the supporting muscles and ligaments, allowing the facet joints to regain their freedom of movement as the spine is urged into flexion and extension as it moves along the exercise surface. The facet joints extend and close or flex and open as the spheres contact them, depending upon which curve of the exercise surface they are in contact with, thereby regaining their natural mobility and function. This in turn results in freedom from pain, increased mobility, greater homeostasis of the body's organs, improved body structure, and increased well-being.

### BRIEF DESCRIPTION OF THE DRAWINGS

The present invention is described with reference to the accompanying drawings. In the drawings, like reference numbers indicate identical or functionally similar elements.

FIG. 1 is a side elevational view of the support table according to the invention.

FIG. 2 is a top plane view of the support table of FIG. 1, showing the exercise surface of the facet-joint exerciser.

FIG. 3 shows pairs of spheres and rollers mounted on the rod, the spheres freely and independently rotatable about the rod.

FIG. 4 shows pairs of spheres and rollers mounted on the rod, the spheres rotatable as a single unit about the rod.

FIG. 5 is a superior view of a typical vertebra, showing the transverse processes, facets, and the spinous process, as well as the soft tissue that supports the spine.

FIG. 6A is a posterior view of the thoracic vertebrae, showing interlocking facet joints.

FIG. 6B is a posterior view of the lumbar vertebrae, showing interlocking facet joints.

FIG. 7 is a posterior view of the thoracic spine, illustraing the web of deep muscles and ligaments that attach to the spine.

FIG. 8 illustrates how the back-muscle exerciser according to the invention exercises the tissue and facet joints.

FIG. 9 is an illustration of a second embodiment of back-exercise apparatus according to the invention, showing a lateral support area that is a smooth, slidable surface.

FIG. 10A is a truncated top plane view of a second embodiment of the facet-joint exerciser, showing a molded surface of partial spheres.

FIG. 10B is a cross-sectional elevational view of the second embodiment of FIG. 10A, illustrating the formed partial spheres.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

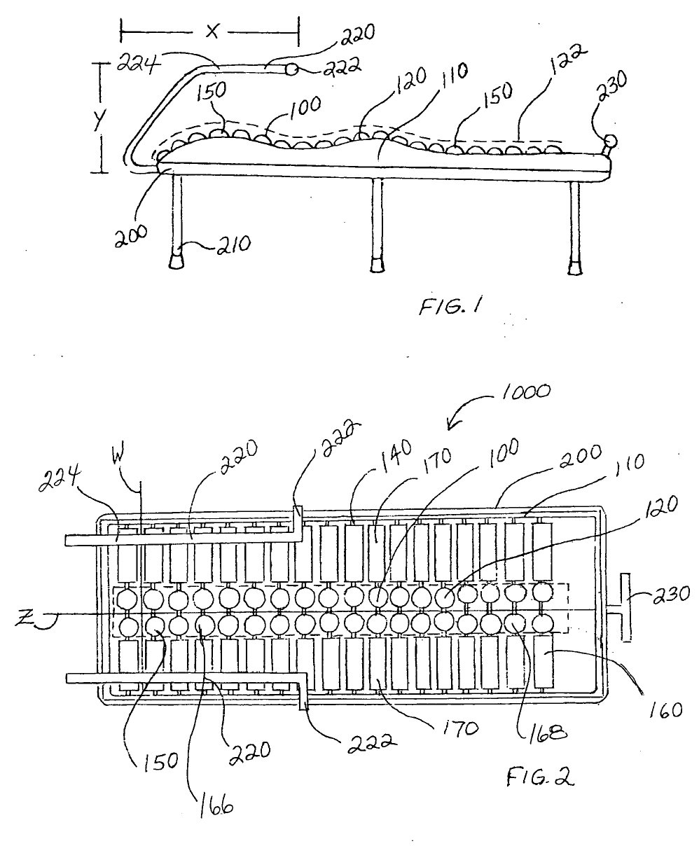

FIG. 1 and FIG. 2 are side and top plane views, respectively, of a facet-joint exerciser 100 according to the invention. The facet-joint exerciser 100 comprises essentially an exercise surface 120 mounted in a frame 110. For illustration purposes, the facet-joint exerciser 100 will be described as having a length dimension, indicated by the longitudinal axis Z, and a width dimension, indicated by the axis W. The exercise surface 120 is constructed of a plurality of rods 140, a plurality of spheres 150 and a lateral support surface 160 for comfortably supporting shoulders and the side portions of the back of the user. In the embodiment shown, rollers 170 mounted on the rods 140 serve as the lateral support surface 120. As can be seen from the FIGS. 1 and 2, the facet-joint exerciser 100 is displaced vertically along a vertical axis Y, so that the exercise surface 120 has an overall curved contour 122 (shown by a dashed line) that accommodates the natural curvature of the human spine.

Still referring to FIGS. 1 and 2, the exercise surface 120 and the lateral support surface 160 are contained within a frame 110 of a rigid, rectangular shape and of sufficient width and length to accommodate a supine human being. In the preferred embodiment of the invention, the rods 140 are attached in parallel to the frame 110 in a manner that will allow each rod 140 to rotate in the frame 110. There are many known ways of mounting the rods 140 and any manner that will allow the rods 140 to rotate is suitable for the exercise surface 120 according to the invention. Spheres 150 and rollers 170 are mounted on the rods 140. The frame 110 has a flat lower surface so that it rests evenly and securely on a level support surface, such as a table, a bench, or even a floor, and has a height that is sufficient to hold the spheres 150 and rollers 170 some distance above the support surface. In the embodiment shown, the upper surface of the frame 110 follows the curved contour 122 of the exercise surface 120. Alternatively, the upper surface of the frame 110 may be flat. The spheres 150 of the embodiment shown are sized so that their upper surface extends above the upper edge of the frame 110. This allows the user to lie on the spheres 150 without coming into contact with the edges of the frame 110. In this embodiment, the spheres 150 are also larger in diameter than the rollers 170, so that when the user is lying on the exercise surface 120, the spheres 150 will protrude up into the back while the shoulders and side areas of the back are supported on the lateral support surface 160, i.e., the rollers 170. In an alternative embodiment, the outer diameter of the spheres 150 and the rollers 170 may be the same, whereby the rollers 170 are constructed of a material that is more easily compressible than the material of the spheres 150, so that the rollers 170 do not prevent the spheres 150 from pressing up into the tissue along the spine of a person lying on the facet-joint exerciser 100.

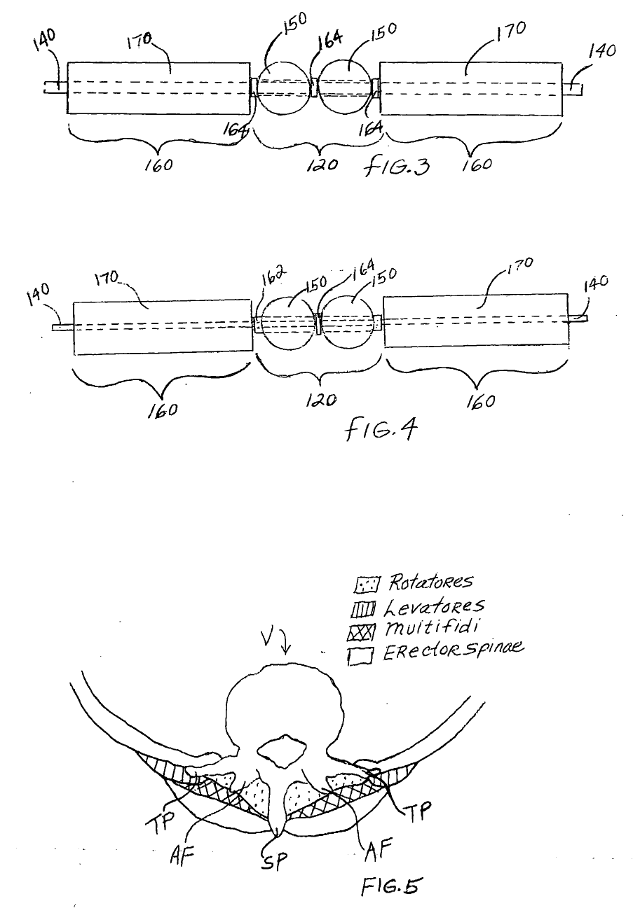

FIGS. 3 and 4 illustrate two embodiments of the exercise surface 120, whereby the rods 140 extend across the entire facet-joint exerciser 100 and also form the lateral support surface 160 with the rollers 140. The exercise surface 120 includes two spheres 150, and spacers or washers 164. Referring briefly back to FIG. 2, it can be seen that the longitudinal axis Z also represents a longitudinally oriented centerline of the exercise surface 120 and that the spheres 150 are arranged in pairs, one on each side of the longitudinal axis Z, to a form double row of the spheres 150, and the rollers 170 are also arranged in pairs, one on each outer end of the rod 140. FIG. 3 illustrates the exercise surface 120 with the two spheres 150 mounted on the rod 140. Each sphere 150 has a bore that is slightly greater in diameter than the diameter of the rod 140, which allows sphere 150 to rotate freely about the rod 140 and independently of the other sphere. The spacers or washers 164 are slid onto the rod 140 as needed to maintain a certain spacing between the two spheres 150 and the lateral support surface 160. It may be desirable to constrain the rotation of the spheres 150 so that they rotate together, as a unit. FIG. 4 illustrates a possible configuration to achieve this effect. The pair of spheres 150 are fixedly mounted on a single sleeve 162, which in turn is dimensioned such that it rotates freely about the rod 140. There are myriad methods of mounting spheres on a rod, rotatedly or fixedly, and any method that provides the desired effect may be employed. The spheres 150 do not have to be independent components, but can also be formed sections of a spindle. For example, in an embodiment in which the spheres 150 are constrained to rotate as a unit, a spindle may be turned on a lathe to form the two spheres 150 together with the rod 140.

Referring again to FIGS. 1 and 2, it can be seen that the facet-joint exerciser 100 is supported on a table 200 to provide back-exercise apparatus 1000. The table 200 has legs 210 and exertion means 220, with which the user may push and pull herself along the exercise surface 120. The exertion means include an overhead grab bar 224 with laterally extending hand grips 222, and a foot brace 230. In the embodiment shown, the facet-joint exerciser 100 includes a frame 110 that is set into the table 200. It is understood, however, that the facet-joint exerciser 100 may be integrated into the table 200, with the table itself forming the frame 110 for the facet-joint exerciser 100.

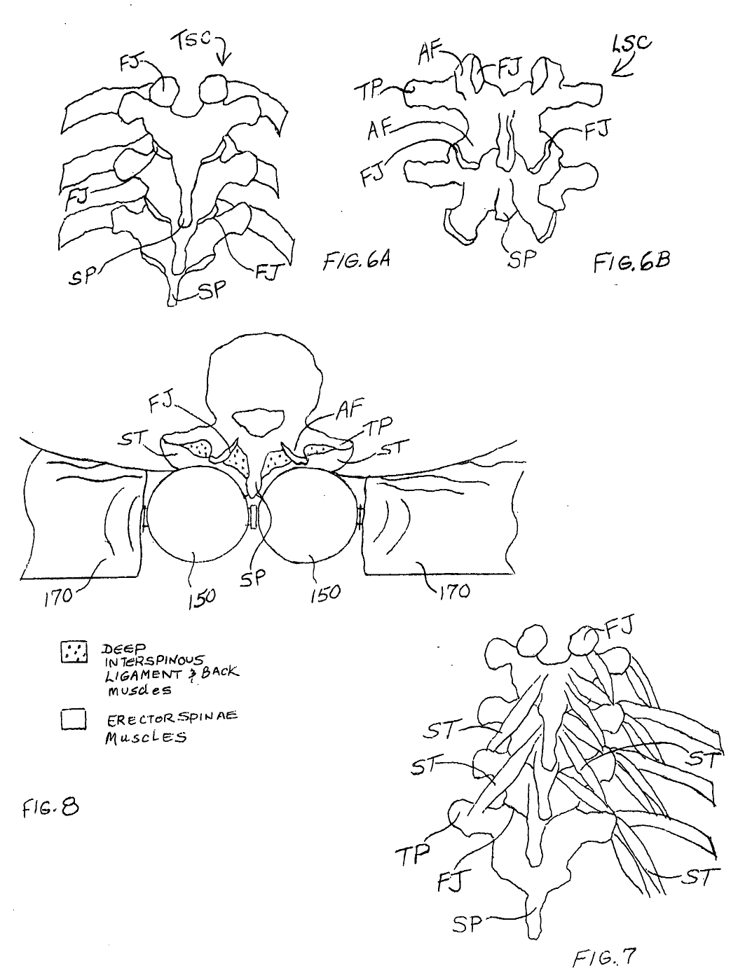

FIGS. 5-7 are provided to illustrate the complexity of the human spinal column and the particular areas that the facet-joint exerciser 100 effectively treats, in order to better understand the efficacy of the invention. FIG. 5 is an illustration of a typical vertebra V, showing transverse processes TP, articular facets AF, the spinous process SP, the vertebral foramen VF and the vertebral body VB. FIGS. 6A and 6B are posterior elevational views of the thoracic spine TSC and the lumbar spine LSC, respectively, showing interlocking facet joints FJ. FIG. 7 is an illustration of the web of muscles and ligaments, referred to collectively as supportive tissue ST, that attach to the spinal column SC. The muscles include rotator, levitor, and the multifidi muscles. These figures are provided only for purposes of illustration. They are not intended to provide an anatomically precise view of the human spine, but rather, to give a general idea of the structure of the posterior spinal column SC and the supportive tissue ST that attaches to it.

Use of the facet-joint exerciser 100 is straightforward. The user lies supine on the exercise surface 120, with his or her spinal column SC centered over the facet joint massage unit 170, and slides from several inches to several feet up and down the exercise surface 120, in the direction indicated by the axis Z. The exercise surface 120 has concave and convex curves, as shown in FIG. 1. Sliding along this surface urges the spinal column SC to flex and extend alternatingly as it moves over convex and concave curves. This flexion and extension relaxes tension in the soft tissue surrounding the facet joints FJ, allowing the facet joints FJ to move more freely. If the facet-joint exerciser 100 is assembled or incorporated into the table 200 with the exertion means 220, the user may use these means to propel the body along the exercise surface 120. If the facet-joint exerciser 100 is a stand-alone device, placed on the floor, for example, the user may use his or her feet to push/pull the body along the exercise surface 120. The effect of the facet-joint exerciser 100 on the user is the same, whether mounted or incorporated into a table or placed on the floor. The rods 140 and rollers 170 rotate as the body moves along the exercise surface 120, facilitating comfortable travel of the body along the surface. The body weight on the facet joint massage unit 160 and the movement of the user along the exercise surface 120 cause the spheres 150 to rotate and to flex as they roll over the uneven contours of the spinal column SC, thereby massaging the supportive tissue ST that supports the facet joints FJ.

FIG. 8 is an illustration of how the spheres 150 of the facet-joint exerciser 100 achieve the goal of releasing tension and correcting subluxation. The illustration shows a superior view of the human spinal column SC with supportive tissue ST, such as deep interspinous ligaments, back muscles, and erector spinae muscles.

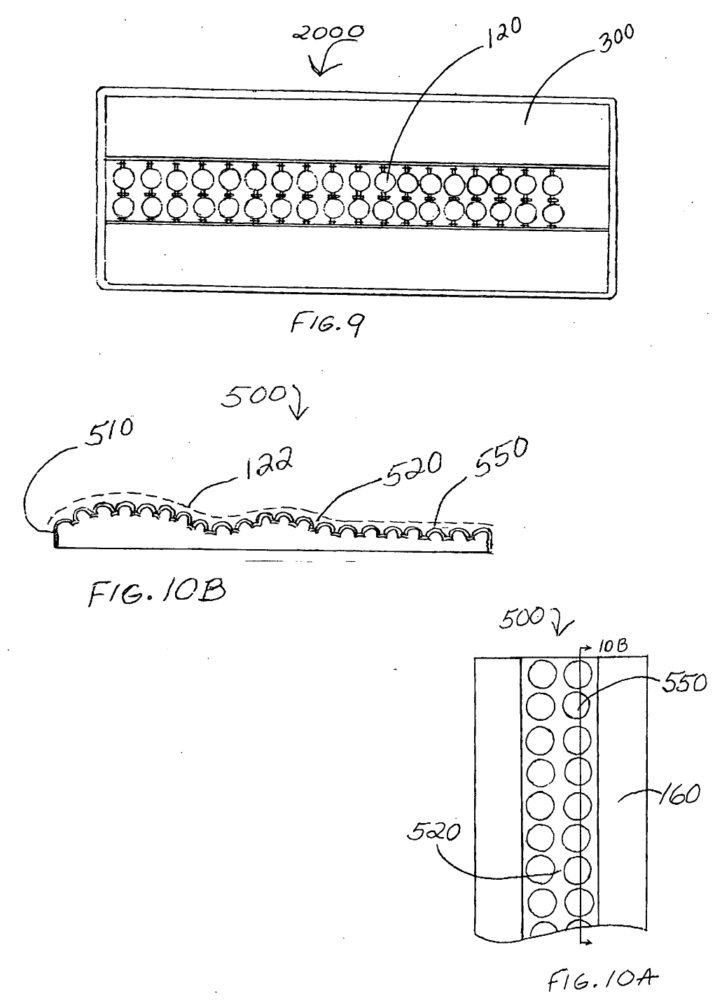

FIG. 9 is a further embodiment of back-exercise apparatus 2000 that comprises the exercise surface 120 described above, mounted in a second embodiment of the lateral support surface 300. Ideally, this lateral support surface 300 is formed to correspond to the curvature of the facet-joint massage unit 160. Various constructions of the lateral support surface 300 are suitable. One such construction is a support surface constructed of a smooth material that allows the body of the user to glide along it easily. For example, a plastic material or a resinous material may be formed to provide the support surface 300 or a smooth sheet material may be fitted over a frame or a sub-construction. Further, the exercise surface 120 may be assembled within the support surface 300 such that it is adjustable in height relative to the support surface 300. Various methods of mounting a device to be adjustable in height are well-known in the art, and such methods are not discussed herein in any detail.

FIGS. 10A and 10B illustrate a second embodiment of a facet-joint exerciser 500 according to the invention. FIG. 10A is a partial plane view of the facet-joint exerciser 500 and FIG. 10B a cross-sectional view of the entire length of the facet-joint exerciser 500. Rather than having the spheres 150 mounted on the rods 140 shown in the first embodiment of the facet-joint exerciser 100, partial spheres or nubs 550 are formed in a base 510 to form an exercise surface 520. The base 510 may be made in any number of ways, with any suitable type of material. For example, the material used for the base 510 may be resin, synthetic, polymeric, composite or other material that can be extruded, molded, or cast. Ideally, the material used to form the facet-joint exerciser 500 is one that allows the body of the user to glide along it easily, with little or no friction. As shown, the base 510 is formed to provide the same overall curved contour 122 of the exercise surface 520 that was shown in the first embodiment in FIG. 2. The partial spheres or nubs 550 formed in the base 510 do not rotate, but are fixed in place. This facet-joint exerciser 500 may be mounted into a frame that provides the previously described lateral support 160, or may be constructed as a unitary article that incorporates both the exercise surface 520 and the lateral support 160.

In the human spine, the facet joints are substantially equidistant from each other along the entire length of the spine. For this reason, in a preferred embodiment of the facet-joint exerciser 100 or 500 constructed for the adult human spine, the spheres 150 are uniform in size, having a diameter in the range of 1.5 inches to 2 inches. Two spheres 150 are spaced close together on the rod 140, and may be spaced the same distance apart on all the rods 140 or be spaced slightly closer together in the areas of the facet-joint exerciser 100 that are intended to provide contact with the cervical and thoracic regions of the spine and slightly farther apart in the area intended to contact the lumbar region. For example, in the area for the cervical and/or thoracic regions, the spheres 150 may be just far enough apart to ensure that they rotate freely and independently of each other, for example, only 1 mm or 0.0394 inch apart, whereas for the lumbar region, where the vertebrae are slightly wider, they may be as much as 1.27 mm or 0.5 inch apart. The rods 140 are spaced apart evenly, the distance depending on the diameter of the spheres used. If the diameter of the spheres 150 is 1.5 inches, for example, the rods 140 may be spaced 2 inches apart. In an ideal configuration, the rods 140 are spaced such that the spheres 150 of adjacent rods 140 are relatively close together to form a straight double-row of free-rolling spheres 150, either for the entire length of the facet-joint exerciser 100 or for the particular area on the exerciser that is intended to work a particular spinal region. In other words, for an area of the exerciser that is intended to work a particular spinal region, the spheres 150 are uniformly spaced along the width axis W, relative to adjacent rows of spheres 150 within the same area, rather than offset, so that two distinct, straight rows of spheres are formed. FIG. 2 illustrates such an arrangement. The last four rows of spheres 150 at the foot end of the exercise surface 120 are spaced farther apart than the other rows, to provide better support for the sacrum. The spacing between spheres 150 for this support area may range between approximately 10 mm or 4 inches. The spacing between spheres 150 in the next few rows above those, in the area intended to treat the lumbar region, would be reduced to accommodate the distance between facet joints in the lumbar region, for example, down to 1.27 mm 0.5 inch. The spacing between spheres 150 in the areas intended to treat the thoracic and cervical areas would be reduced even further, such that the spheres 150 are just far enough apart to rotate freely and independently of each other. For illustrative purposes only, FIG. 2 shows a first straight double-row of spheres 166 in the area of the facet-joint exerciser intended to treat the cervical, thoracic, and lumbar regions of the spine, and a second double-row of spheres 168 in the area intended to support the sacrum. It is understood that the spheres 150 in the other areas of the exercise surface 120 may be spaced closer together to more closely track the distance between facet joints in those areas. The dimensions provided herein are provided merely for guidance in configuring a facet-joint exerciser that is sized for the average human adult. The dimensions of the spheres and the spacing between spheres in one row and between rows may vary, depending on the particular intended use of such an exerciser.

The spheres 150 may be constructed of a natural or a synthetic material. Ideally, the spheres 150 have a hard core and a soft, flexible and compressible outer surface. The outer surface may be smooth or textured. The rollers 170 may be constructed of materials similar to that used for the spheres, or of a rigid material, such as wood, metal, plastic or other form rigid material. An outer foam padding for comfort is optional. The outer diameter of the rollers 170 may be smaller than the diameter of the spheres 150, or may be the same or greater than the diameter of the spheres 150. In the latter case, the rollers 140 are constructed of a material that has greater compressibility than the material used for the spheres 150, so that when the user lies on the exercise surface 120, the rollers 140 compress to the extent that they do not hinder the spheres 150 from pushing into the areas between the facet joints FJ.

The embodiments of the invention mentioned herein are merely illustrative of the present invention. It should be understood that a person skilled in the art may contemplate many variations in construction of the present invention in view of the following claims without straying from the intended scope and field of the invention herein disclosed.

What is claimed is:

1. Massage apparatus for massaging tissue around a spinal column of a user, said massage apparatus comprising:
a massage surface formed by a plurality of rods arranged parallel to each other and transverse to said longitudinal axis; and
a plurality of spheres that are uniformly sized;
wherein at least two spheres of said plurality of spheres are mounted on each rod of said plurality of rods, spaced equidistant about said longitudinal axis.

2. The massage apparatus of claim 1, said massage surface further comprising:
a plurality of rollers;
wherein said each rod has a first end and a second end and a first roller of said plurality of rollers is mounted between a first one of said at least two spheres and said first end and a second roller of said plurality of rollers is mounted between a second one of said at least two spheres and said second end.

3. The massage apparatus of claim 2, wherein said spheres have a sphere diameter and said rollers have a roller diameter that is smaller than said sphere diameter.

4. The massage apparatus of claim 2, wherein said spheres have a sphere diameter and said rollers have a roller diameter that is equal to said sphere diameter.

5. The massage apparatus of claim 4, wherein spheres have a sphere compressibility and said rollers have a roller compressibility that is greater than that of said sphere compressibility.

6. The massage apparatus of claim 1, wherein said frame has a height dimension and wherein portions of said massage surface are vertically displaced within said height dimension so as to provide a curved massage surface.

7. The massage apparatus of claim 1, further comprising exertion means, against which said user exerts force in order to slide said spinal column along said massage surface.

8. The massage apparatus of claim 7, wherein said exertion means includes a hand grip means for said user to grasp and push and pull against.

9. The massage apparatus of claim 8, wherein said hand grip means is a grip bar mounted above said frame.

10. The massage apparatus of claim 8, wherein said hand grip means is a grip bar mounted on each side of said frame.

11. The massage apparatus of claim 7, wherein said frame has a head end and a foot end and said exertion means is a foot brace mounted at said foot end of said frame.

12. The massage apparatus of claim 1, wherein said frame includes support legs.

13. The massage apparatus of claim 1, said massage surface further comprising a lateral support surface with a low coefficient of friction, wherein said lateral surface extends parallel to said longitudinal axis and allows said user to slide thereupon.

14. The massage apparatus of claim 13, wherein said lateral support surface includes a plurality of smooth spindles that extend parallel to said longitudinal axis and are dimensioned so as to support a body weight of said user.

15. The massage apparatus of claim 13, wherein said lateral support surface is a continuous surface.

16. The massage apparatus of claim 1, wherein said spheres have a sphere diameter within a range of one and one-half inches and two inches.

17. The massage apparatus of claim 1, wherein a distance between said two spheres is within a range of 0.0394 inch to 0.5 inch.

18. Massage apparatus for massaging tissue around a spinal column of a user, said massage apparatus comprising:
a massage surface formed on a base, said massage surface having a longitudinal axis and a height dimension, said massage surface formed by a plurality of partial spheres that are molded in said base;
wherein said partial spheres are uniformly sized in diameter and wherein at least two partial spheres are molded into said base, spaced equidistant about said longitudinal axis.
